(19) United States
(12) Patent Application Publication
(10) Pub. No.: US 2009/0279917 A1
(43) Pub. Date: Nov. 12, 2009

(54) Resilient driving force member

(76) Inventors: Samuel Wai Keung Tsui, Shenzhen (CN); Alexander Slocum, Bow, NH (US)

Correspondence Address: GCC IP Pty Ltd, P O Box 2920, Geraldton, WA 6530, AU

(21) Appl. No.: 11/632,577

(22) PCT Filed: Jul. 25, 2005
(86) PCT No.: PCT/US05/26130

§ 371 Date: Feb. 7, 2008

(30) Foreign Application Priority Data
Jul. 23, 2004 (AU) 2004904093
Oct. 6, 2004 (AU) 2004905738

(51) Int. Cl. G03G 21/16; G03G 15/08; F16D 3/00; F16D 3/10

(52) U.S. Cl. 399/111; 399/117; 399/119; 464/160

(57) ABSTRACT

A resilient driving force member 10 having at least one helical spring 16, each helical spring 16 having an support member 14 connected to one end thereof and an engaging portion 20 connected to the other end, the engaging portion extending further from an axis X central to the turns of the helical spring 16 than the turns, where the engaging portion 20 of the resilient driving force member 10 is adapted to engage a corner or side of another driving force member of substantially similar size having either a twisted or non-twisted recess such that, when so engaged, rotational driving force can be transferred from one driving force member to the other.

### FIELD OF THE INVENTION

The invention relates to a resilient driving force member. The resilient driving force member is particularly suited to receive a rotational driving force transferred by way of an additional driving force member taking the form of either a twisted or non-twisted recess.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Driving force members. are commonly used in any situation where a rotational driving force needs to be transferred from one article to components of another article. Typically, the two driving force members are configured such that the internal profile of one is matched to the external profile of the other. This match in profiles is often an identical match.

Recently, in the field of process and developer cartridges, driving force members included to transfer rotational driving force from an image processing apparatus to the photosensitive drum, or like components, have been implemented in the form of a twisted projection to be received within a twisted recess. While the use of driving force members having twisted profiles have produced benefits in the form of the driving force member being self-centring and also assisting in preventing disengagement of the driving force members while a rotational driving force is being applied, it has also introduced further complications. For instance:

Existing driving force members not having a twisted profile can not be used with a driving force member having a twisted profile because the point of engagement between the two driving force members is insufficient to facilitate the transfer of the rotational driving force;

A driving force member having a twisted profile requires further precision tooling equipment to meet the exacting tolerances the twisted profile sets; and

A driving force member having a twisted profile is prone to breakage along its length by reason of its twisted profile. When breakage occurs, the failed components have significant rotational driving force applied to them and thus often cause damage to other components near the driving force members.

It is therefore an object of the present invention to create a driving force member that seeks to provide at least one of the advantages of a driving force member having a twisted profile and that can be used with driving force members having either a twisted recess or non-twisted recess profile.

It should be appreciated that while the following description will be made in relation to image processing equipment, it is not restricted to such use and may be used in any circumstance where rotational driving force is required to be imparted from one component to another.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is a resilient driving force member having at least one helical spring, each helical spring having an support member connected to one end thereof and an engaging portion connected to the other end, the engaging portion extending further from an axis central to the turns of the helical spring than the turns, where the engaging portion of the resilient driving force member is adapted to engage a corner or side of another driving force member of substantially similar size having either a twisted or non-twisted recess such that, when so engaged, rotational driving force can be transferred from one driving force member to the other.

Preferably, the engaging portion has a long length extending therefrom parallel to the central axis. The profile of the long length may match at least a portion of the profile of the twisted recess of the driving force member it is adapted to engage. Furthermore, the twisted recess may have a degree of twist in the range of 1° to 15° per mm of the axial length of the recess.

Ideally, the resilient driving force member has three helical springs intertwined into a triple helix configuration. Preferably, the engaging portions are substantially equidistant to one another. Similarly, it is also preferred if the support members are substantially equidistant to one another.

The engaging portion may be positioned opposite the support member relative to the central axis. The support members may be mounted on a base. The resilient driving force member may also include an electroconductive portion.

In accordance with a second aspect of the invention there is a photosensitive drum including a resilient driving force member according to the first aspect of the invention, the central axis of the resilient driving force member being concentric with the rotational axis of the photosensitive drum.

In accordance with a third aspect of the invention there is a drum hub including a resilient driving force member according to the first aspect of the invention, the drum hub adapted to engage a photosensitive drum such that the central axis of the resilient driving force member of the drum hub is concentric with the rotational axis of the photosensitive drum.

In accordance with a fourth aspect of the invention there is a process cartridge including a photosensitive drum according to the second aspect of the invention or a drum hub according to the third aspect of the invention.

In accordance with a fifth aspect of the invention there is a developer cartridge including a developer roller having a resilient driving force receiving member according to the first aspect of the invention, the central axis of the resilient driving force receiving member being concentric with the rotational axis of the developer roller.

### BRIEF DESCRIPTION OF THE DRAWINGS

The invention will now be described, by way of example only, with reference to the accompanying drawings, in which:

FIG. 1 is a plan view of a first resilient driving force member according to the invention.

FIG. 2 is an isometric view of a second resilient driving force member according to the invention.

FIG. 3 is an isometric view of a third resilient driving force member according to the invention.

FIG. 4 is an isometric view of a fourth resilient driving force member according to the invention.

FIG. 5 is an isometric view of a photosensitive drum including the second resilient driving force member as shown in FIG. 2.

FIG. 6 is an isometric view of a drum hub including the fourth resilient driving force member as shown in FIG. 4.

FIG. 7 is an isometric view of a developer cartridge including a photosensitive drum as shown in FIG. 5.

FIG. 8a is an isometric view of a driving force member taking the form of a twisted recess. FIG. 8b is a cross-sectional view of the driving force member shown in FIG. 8a.

FIG. 9 is a schematic representation of the driving force member of FIG. 5 received within the driving force member of FIG. 8.

FIG. 10 is a schematic representation of the driving force member of FIG. 6 received within the driving force member of FIG. 8.

### PREFERRED EMBODIMENTS OF THE INVENTION

In accordance with a first embodiment of the invention there is a resilient driving force member 10. The driving force member 10 comprises a resilient member 12.

The resilient member 12 comprises a support member 14, a helical spring 16 and an engaging portion 20. The support member 14 connects to the helical spring 16 at a first end 18. The support member 14 extends away from the helical spring 16 in a manner parallel to a central axis X of the helical spring 16.

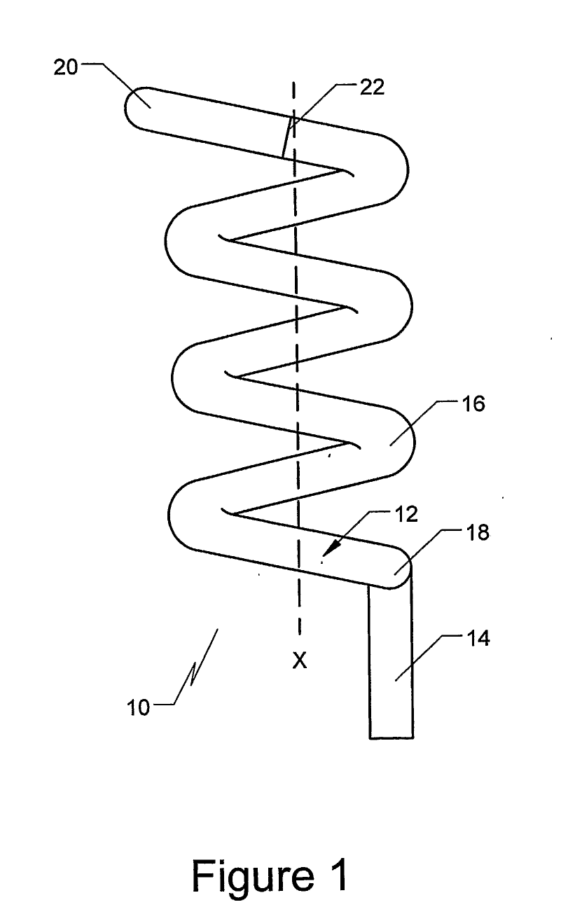

The helical spring 16 is formed such that the profile of each turn is centred on the central axis X. In the preferred form of this embodiment, as shown in FIG. 1, the helical spring 16 has approximately three full and one quarter turn.

The engaging portion 20 connects to the helical spring 16 at a second end 22. As shown in FIG. 1, using the first end 18 as the originating point for the turns of the helical spring 16, the engaging portion 20 is positioned opposite the support member 14 as determined with reference to the central axis X.

In accordance with a second embodiment of the invention, where like numerals reference like parts, there is a resilient driving force member 100. The resilient driving force member 100 comprises three resilient driving force members 10 as described in the first embodiment of the invention intertwined to form a triple helix.

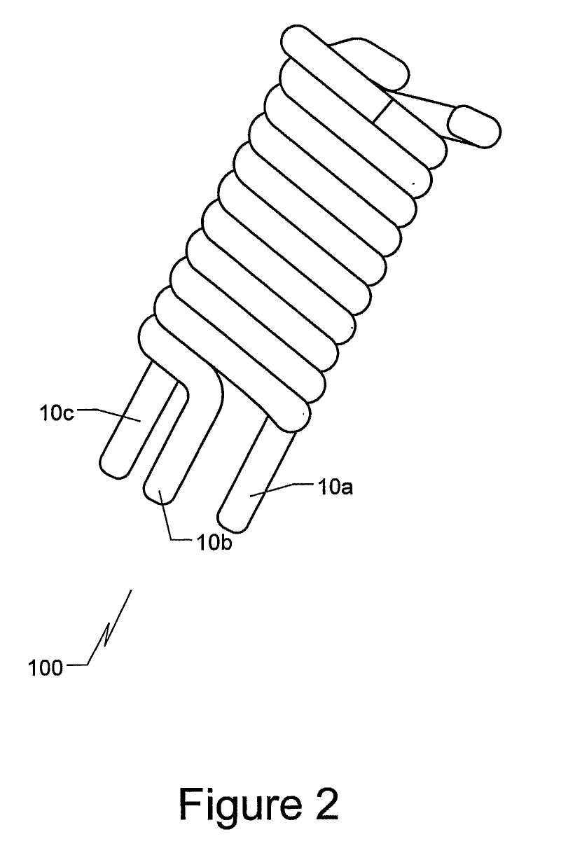

The resilient driving force member 100 is formed such that the support members 14 are substantially equidistant from one another. Further, the engaging portions 20 are also substantially equidistant from each other. This arrangement is shown graphically in FIG. 2.

In accordance with a third embodiment of the invention, where like numerals reference like parts, there is a resilient driving force member 200. The resilient driving force member 200 is identical in construction to the resilient driving force member 10 excepting the configuration of the engaging portion 20.

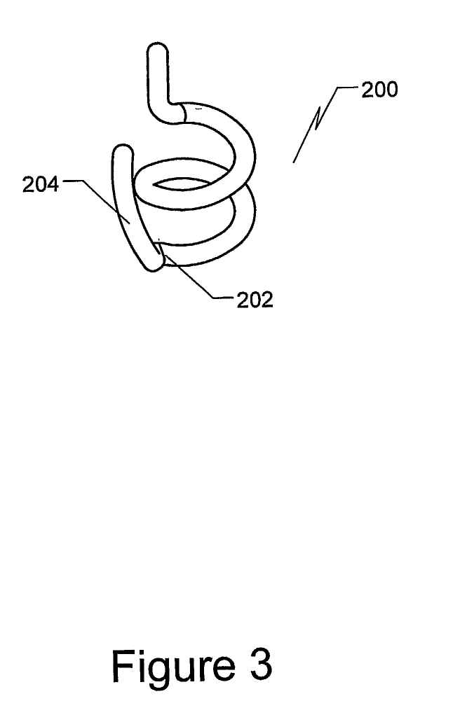

In this third embodiment, the engaging portion 20 is substantially L-shaped. The smaller length 202 of the engaging portion 20 extends away from the central axis X in a direction perpendicular thereto. The larger length 204 of the engaging portion 20 has a slight curve. The larger length 204 of the engaging portion 20 is positioned such that, while accounting for the slight curve, it is substantially parallel to the central axis X. Furthermore, the larger length 204 of the engaging portion 20 extends back towards the support member 14, such that it extends past at least one turn of the helical spring 16. In this manner, the larger length 204 provides extra stability and resistance to deformity in directions perpendicular to the central axis X to resilient driving force member 200. This is shown graphically in FIG. 3.

In accordance with a fourth embodiment of the invention, where like numerals reference like parts, there is a resilient driving force member 300. The resilient driving force member 300 comprises three resilient driving force members 200 as described in the third embodiment of the invention intertwined to form a triple helix.

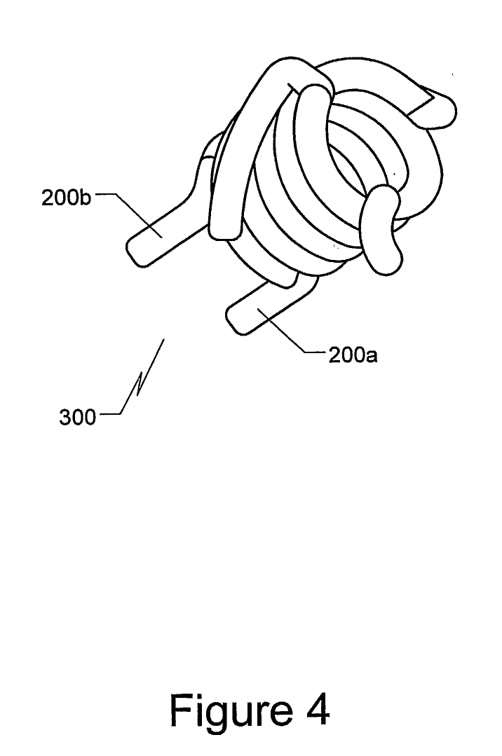

The resilient driving force member 300 is formed such that the support members 14 are substantially equidistant from one another. Further, the engaging portions 20 are also substantially equidistant from each other. This arrangement is shown graphically in FIG. 4.

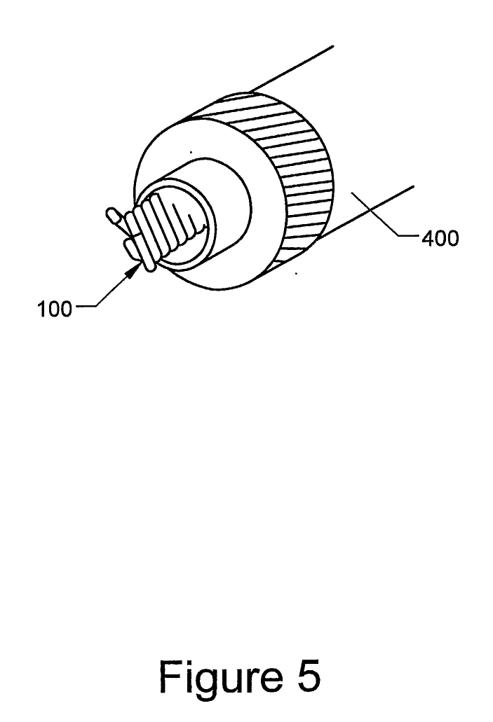

In accordance with a fifth embodiment of the invention, there is a photosensitive drum 400 adapted to have the resilient driving force member 100 of the second embodiment received therein. The resilient. driving force member 100 is positioned such that the central axis X coincides with the rotational axis of the photosensitive drum 400. See FIG. 5.

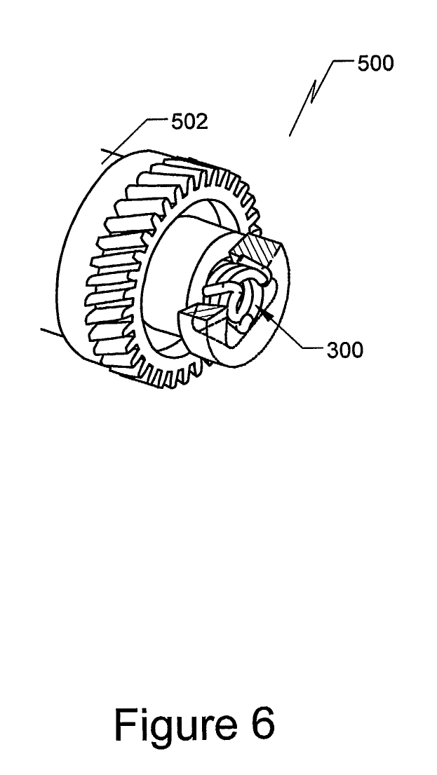

In accordance with a sixth embodiment of the invention, there is a drum hub 500 adapted to receive the driving force member 300 of the fourth embodiment. See FIG. 6. The drum hub 500 is further adapted to engage a photosensitive drum 502. Again the resilient driving force member 300 is positioned such that the central axis X coincides with the rotational axis of the photosensitive drum 502.

In accordance with a seventh embodiment of the invention, there is a developer cartridge including a developer roller adapted to have the driving force member 100 of the second embodiment received therein. The centre of the driving force member 100 is located on the rotation axis of the developer roller. The driving force member 100 is integrally formed with the rotation shaft having its rotation axis concentric with the rotation axis of the developer roller. As a developer cartridge is well known to the person skilled in the art, the other components that make up the developer cartridge will not be described here. However, the preferred implementation of this embodiment comprises a developer cartridge including the developer roller and toner container.

In accordance with an eight embodiment of the invention, there is a process cartridge including a photosensitive drum according to the fourth embodiment of the invention. As a process cartridge is well known to the person skilled in the art, the other components that make up the process cartridge will not be described here. However, the preferred implementation of this embodiment comprises a process cartridge including the photosensitive drum as already mentioned, a toner container, a developer roller, a cleaning blade, a charge roller and a scavenger unit.

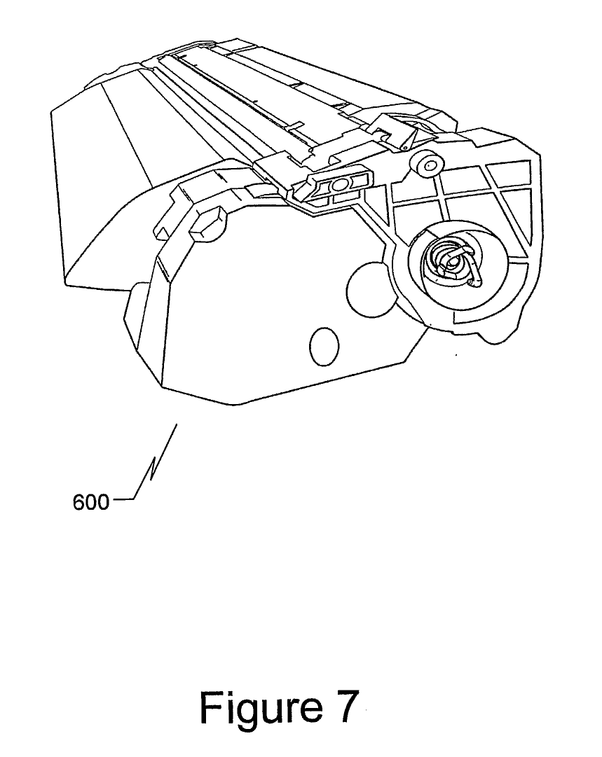

The invention will now be described in use with respect to a developer cartridge 600 according to the seventh embodiment of the invention. This configuration is shown in FIG. 7

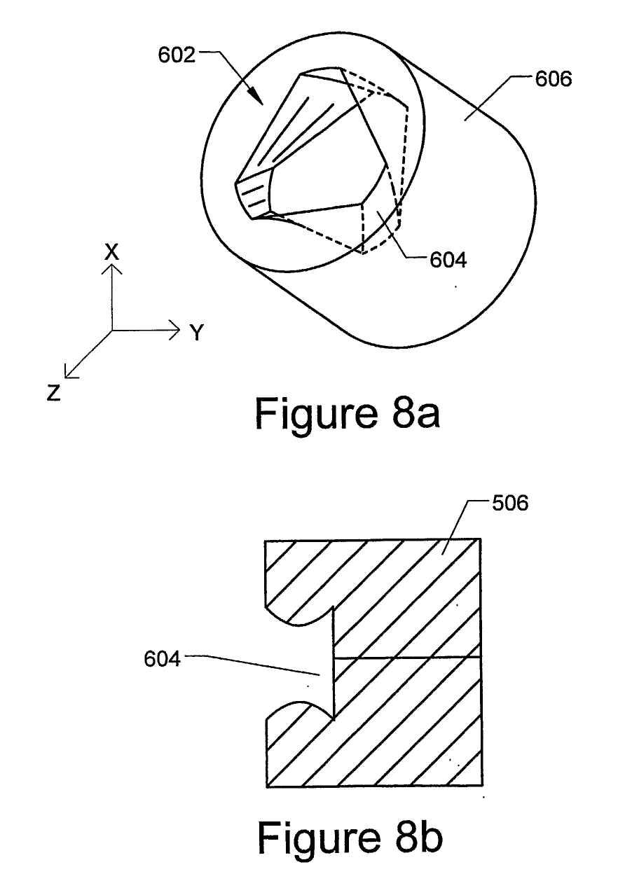

The developer cartridge 600 is adapted to be received within an image processing apparatus (not shown). The image processing apparatus has a driving force member 602 positioned therein adapted to receive the driving force member 100 when the developer cartridge 600 is received within the image processing apparatus. The driving force member 602 of the image processing apparatus is shown in FIGS. 8a and 8b.

The driving force member 602 of the image processing apparatus is a recess 604 integrally formed within a drive shaft 606 of the image processing apparatus. The recess 604 is a polygonal shape twisted in the rotational direction R of the drive shaft 606. The recess 604 has a cross-section in the xy plane of a substantially equilateral triangle. The degree of twist in the recess 604 is approximately 7.5° per 1 mm of the axial length of the recess 604.

The relationship between the recess 604 and the driving force member 100 can be shown by the rule d1<d0<d2, where d0 is the diameter of a circumscribed circle of the triangular prism as defined by the engaging portions 20 of the driving force member 100, d1 is the diameter of the inscribed circle of the triangle of the recess 604 and d2 is the diameter of the circumscribed circle of the triangle of the recess 604.

When the developer cartridge 600 is received within the image processing apparatus, the drive shaft 606 moves from a retracted position to an engaged position by way of the urging force applied to it by a weak spring. In the engaged position, the driving force member 602 engages the driving force member 100. The process of engagement and subsequent transfer of rotational driving force, will now be described in detail.

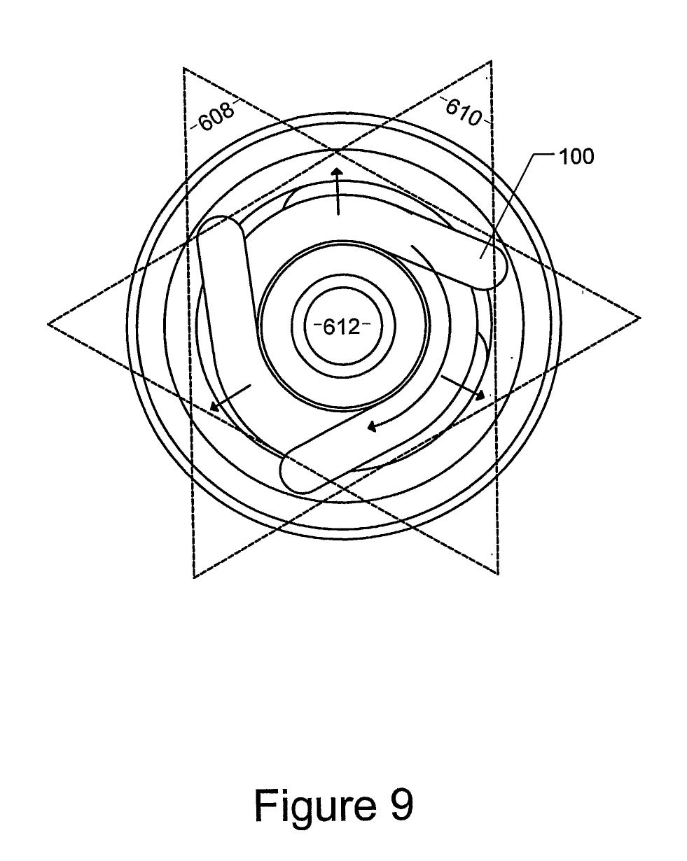

FIG. 9 shows a schematic of the driving force member 100 as received within the driving force member 602. The twisted configuration of the recess 604 is represented by the first equilateral triangle 608 and second equilateral triangle 610. First equilateral triangle 608 represents the cross-section profile of the recess 604, as taken in the xy plane, at the aperture opening. Second equilateral triangle 610 represents the cross-sectional profile of the recess 604, as taken in the xy plane, at the bottom of the aperture.

As is depicted in FIG. 9 the shape of the driving force member 100 is such that it fits within the “free space” 612 represented by the intersection of the first equilateral triangle 608 and the second equilateral triangle 610. In this manner, the driving force member 100 is able to be received completely within recess 604.

As driving force member 100 is received within recess 604 the ends of the engaging portions 20 may deform slightly. Alternatively, the ends of the engaging portions 20 may follow the twisted profile of the recess 604 without deformation. In either case, when the driving force member 100 is received within the recess 604, as rotational driving force is applied to the driving force member 100 by driving force member 602, the driving force member 100 moves to a second position in line with the second equilateral triangle 610. In this the second position, the direction of the twisted configuration of the recess 604 relative to the direction of rotational driving force prevents the driving force member 100 from moving along the z axis and thereby exiting the recess 604.

While also in this second position, the engaging portions 20 of the driving force member 100 are in regular contact with the inside surfaces of the recess 604. In this manner, the centre of the driving force member 100 aligns with the centre of the recess 604 as part of the process of rotation. This provides the added advantage of rotation accuracy due to a minimisation of rotation non-uniformity of the coupling driving due to load variation and also to minimise changes in contact points.

Once regular contact has been made, rotational driving force applied to driving force member 602 can be efficiently conveyed to driving force member 100.

The same resilient driving force member 100 can also be received within a driving force member (not shown) of substantially similar size having a non-twisted polygonal recess. In this configuration, once the resilient driving force member 100 is received within the non-twisted recess, the application of rotational driving force causes the engaging portions to contact the sides of the recess. The extent of contact is determined by the profile of the non-twisted polygonal recess relative to the profile of the resilient driving force member 100. However, once contact is made, the resilient nature of the resilient driving force member 100 maintains the contact.

The rotational driving force applied to the driving force member is then conveyed to driving force member 100.

The invention will now further be described in use with respect to a process cartridge (not shown) according to the eighth embodiment of the invention.

As with the developer cartridge mentioned above, the process cartridge is adapted to be received within an image processing apparatus. The image processing apparatus has a driving force member 602 positioned therein adapted to receive the driving force member 300 when the process cartridge is received within the image processing apparatus. The driving force member 602 of the image processing apparatus is shown in FIGS. 8a and 8b.

The driving force member 602 of the image processing apparatus is a recess 604 integrally formed within a drive shaft 606 of the image processing apparatus. The recess 604 is a polygonal shape twisted in the rotational direction R of the drive shaft 606. The recess 604 has a cross-section in the xy plane of a substantially equilateral triangle. The degree of twist in the recess 604 is approximately 7.5° per 1 mm of the axial length of the recess 604.

The relationship between the recess 604 and the driving force member 300 can be shown by the rule d1<d0<d2, where d0 is the diameter of a circumscribed circle of the triangular prism as defined by the points of connection between the smaller length 202 and the larger length 204 of each engaging portion 20, d1 is the diameter of the inscribed circle of the triangle of the recess 604 and d2 is the diameter of the circumscribed circle of the triangle of the recess 604.

When the process cartridge is received within the image processing apparatus, the drive shaft 606 moves from a retracted position to an engaged position by way of the urging force applied to it by a weak spring. In the engaged position, the driving force member 602 engages the driving force member 300. The process of engagement and subsequent transfer of rotational driving force, will now be described in detail.

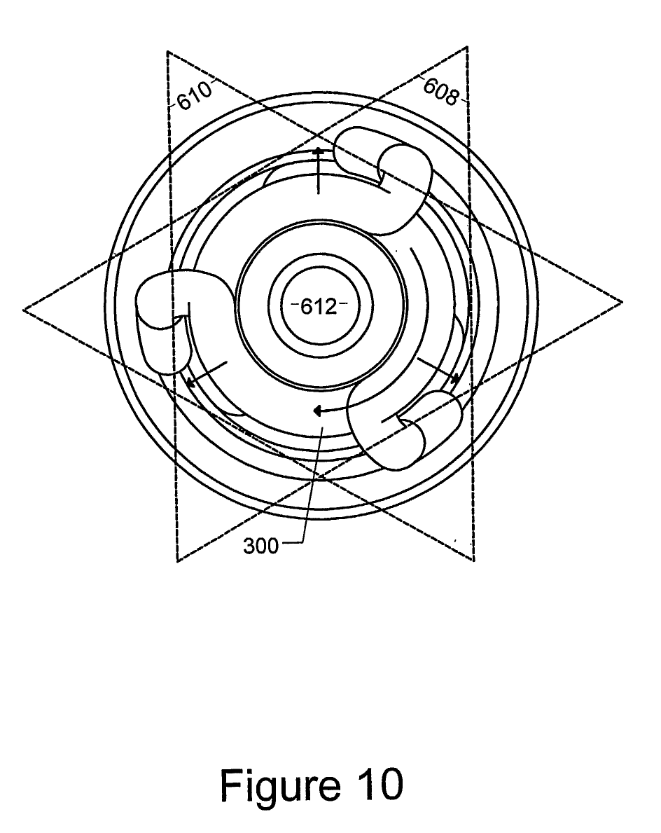

FIG. 10 shows a schematic of the driving force member 300 as received within the driving force member 602. The twisted configuration of the recess 604 is represented by the first equilateral triangle 608 and second equilateral triangle 610. First equilateral triangle represents the cross-section profile of the recess 604, as taken in the xy plane at the aperture opening. Second equilateral triangle 610 represents the cross-sectional profile of the recess 604, as taken in the xy plane, at the bottom of the aperture.

As is depicted in FIG. 10 the shape of the driving force member 300 is such that it fits within the “free space” 612 represented by the intersection of the first equilateral triangle 608 and the second equilateral triangle 610. In this manner, the driving force member 300 is able to be received completely within recess 604.

As driving force member 300 is received within recess 604 the engaging portions 20 may deform slightly. Alternatively, the ends of the engaging portions 20 may follow the twisted profile of the recess 604 without deformation. In either case, when the driving force member 100 is received within the recess 604, as rotational driving force is applied to the driving force member 300 by driving force member 602, the driving force member 300 moves to a second position in line with the second equilateral triangle 610. In this the second position, the direction of the twisted configuration of the recess 604 relative to the direction of rotational driving force prevents the driving force member 300 from moving along the z axis and thereby exiting the recess 604.

While also in this second position, the engaging portions 20 of the driving force member 300 are in regular contact with the inside surfaces of the recess 604 as defined by its twisted profile. This also facilitates the alignment of the centre of the driving force member 300 with the centre of the recess 604 as part of the process of rotation. The self-centring provides the added advantage of rotation accuracy and minimisation of rotation non-uniformity of the coupling driving due to load variation. It also minimises any changes in contact points.

Once regular contact has been made, rotational driving force applied to driving force member 602 can be efficiently conveyed to driving force member 100.

The same resilient driving force member 100 can also be received within a driving force member (not shown) of substantially similar size having a non-twisted polygonal recess. In this configuration, once the resilient driving force member 100 is received within the non-twisted recess, the application of rotational driving force causes the engaging portions to contact the sides of the recess. The extent of contact is determined by the profile of the non-twisted polygonal recess relative to the profile of the resilient driving force member 100. However, once contact is made, the resilient nature of the resilient driving force member 100 maintains the contact.

The rotational driving force applied to the driving force member is then conveyed to driving force member 100.

It should further be appreciated by the person skilled in the art that while the above examples have been provided with reference to the triple helix configurations, the same result can be achieved using a single driving force member (albeit with less efficiency) where the resilient driving force member is able to engage a corner of the recess.

As would be evident from the above description, the resilient driving force members described are easy to manufacture and do not require high-precision tooling equipment to do so. Further, the configuration of the resilient driving force members described are such that any failure of the component is unlikely to result in breakage along its length. Therefore, the resilient driving force member should still be able to facilitate the transfer of rotational driving force even in the event of breakage. As this is also likely to result in smaller failed components, the damage potentially caused to other components near the driving force members is also likely to be minimised.

It should be appreciated by the person skilled in the art that the above invention is not limited to the embodiment described. In particular, the following modifications and improvements may be made without departing from the scope of the present invention:

The support members 14 may be mounted to a base, such as a short-cylinder base, to provide additional stability to the overall driving force member 10.

The number of turns in the helical spring 16 may be more or less than the numbers described herein.

The number of resilient driving force members 10 used to create a further resilient driving force member, such as driving force member 100, may vary. In doing so, the spacing between turns in the helical spring 16 may also vary to accommodate the additional resilient driving force members 10 and also to adapt to the situation to which the further resilient driving force member is to be put.

The resilient driving force member 10 may include an electroconductive portion or be completely formed from an electrically conductive material. This allows the resilient driving force member to ground electrical components to which it is connected. For example, the resilient driving force member 10 may have a conductive shaft provided at its centre.

The recess may have other configurations to that described above. For instance, the recess may be rectangular or any other polygonal shape, or the recess may have a cross-sectional profile equal to an isosceles triangle.

The resilient driving force member may be adapted to engage a driving force member in the form of a twisted recess where the degree of twist is anywhere from 1° to 15° per 1 mm of the axial length of the recess.

The driving force member may be used to rotate a component of the process cartridge other than the photosensitive drum—for instance, the driving force member may be used to rotate a developer roller and/or agitator contained within the toner container.

It should be further appreciated by the person skilled in the art that the features described in one embodiment, where not mutually exclusive or alternatives, may be combined with features described in other embodiments described to create yet further embodiments that fall within the scope of the present invention.

We claim:

1. A resilient driving force member having at least one helical spring, each helical spring having an support member connected to one end thereof and an engaging portion connected to the other end, the engaging portion extending further from an axis central to the turns of the helical spring than the turns, where the engaging portion of the resilient driving force member is adapted to engage a corner or side of another driving force member of substantially similar size having either a twisted or non-twisted recess such that, when so engaged, rotational driving force can be transferred from one driving force member to the other.

2. A resilient driving force member according to claim 1, where the engaging portion has a long length extending therefrom parallel to the central axis.

3. A resilient driving force member according to claim 2, where the profile of the long length matches at least a portion of the profile of the twisted recess of the driving force member it is adapted to engage.

4. A resilient driving force member according to claim 3, where the twisted recess has a degree of twist in the range of 1° to 15° per mm of the axial length of the recess.

5. A resilient driving force member according to any preceding claim, where the resilient driving force member has three helical springs intertwined into a triple helix configuration.

6. A resilient driving force member according to any preceding claim, where the engaging portions are substantially equidistant to one another.

7. A resilient driving force member according to any preceding claim, where the support members are substantially equidistant to one another.

8. A resilient driving force member according to any preceding claim where the engaging portion is positioned opposite the support member relative to the central axis.

9. A resilient driving force member according to any preceding claim, where the support members are mounted on a base.

10. A resilient driving force member according to any preceding claim including an electroconductive portion.

11. A photosensitive drum including a resilient driving force member according to any one of claims 1 to 10, the central axis of the resilient driving force member being concentric with the rotational axis of the photosensitive drum.

12. A drum hub including a resilient driving force member according to any one of claims 1 to 10, the drum hub adapted to engage a photosensitive drum such that the central axis of the resilient driving force member of the drum hub is concentric with the rotational axis of the photosensitive drum.

13. A process cartridge including a photosensitive drum according to claim 11 or a drum hub according to claim 12.

14. A developer cartridge including a developer roller having a resilient driving force receiving member according to any one of claims 1 to 10 attached thereto, the central axis of the resilient driving force receiving member being concentric with the rotational axis of the developer roller.

15. A resilient driving force member substantially as described herein with reference to the drawings, excepting FIGS. 8a and 8b.
